(19) United States
(12) Patent Application Publication
(10) Pub. No.: US 2018/0182214 A1
(43) Pub. Date: Jun. 28, 2018

(54) Mobile Device Security System

(71) Applicant: MivaLife Mobile Technology, Inc., Grand Cayman (KY)

(72) Inventors: Yan Qi, Fremont, CA (US); Chi-Chih Fishman Yu, Taipei (TW); Joseph Y. Liu, Fremont, CA (US)

(21) Appl. No.: 15/851,426

(22) Filed: Dec. 21, 2017

Related U.S. Application Data
(60) Provisional application No. 62/438,213, filed on Dec. 22, 2016.

(51) Int. Cl. G08B 13/196; H04L 29/06; H04W 12/06; H04W 12/08; G06K 7/14; H04N 7/18; H04M 1/725; G08B 25/10

(52) U.S. Cl. CPC G08B 13/19656; H04L 63/107; H04L 63/083; H04W 12/06; H04W 12/08; G08B 25/10; H04N 7/188; G08B 13/19684; H04M 1/72525; H04M 1/72569; G06K 7/1417

(57) ABSTRACT

Methods, systems, and apparatus, including computer programs encoded on computer storage media, for using a mobile device to provide security system functionality. One of the systems includes a first mobile device, the first mobile device including one or more installed applications for providing security system management; a service provider system communicatively coupled to the first mobile device; and a user mobile device configured to provide user access to security system information from the first mobile device through the service provider system.

### CROSS-REFERENCE TO RELATED APPLICATIONS

This application claims the benefit under 35 U.S.C. § 119(e) of the filing date of U.S. Patent Application No. 62/438,213, for Cellular Frequency Band Agnostic Wireless Home Security System, which was filed on Dec. 22, 2016, and which is incorporated here by reference.

### BACKGROUND

This specification relates to using a mobile device to provide security system functionality.

Conventional security systems can include one or more security cameras and/or one or more sensors positioned at different points of a security system location, e.g., a home or office. Some conventional home security systems use a public switched telephone network (PSTN) to transmit alerts to an authorized call service provider using dual-tone multi frequency (DTMF) signaling. A live operator at the call service provider services incoming alarms, e.g., by calling the police.

### SUMMARY

This specification describes technologies relating to using a mobile device as a self-contained or manager of a security system.

In general, one innovative aspect of the subject matter described in this specification can be embodied in security systems that include a first mobile device, the first mobile device including one or more installed applications for providing security system management; a service provider system communicatively coupled to the first mobile device; and a user mobile device configured to provide user access to security system information from the first mobile device through the service provider system. Other embodiments of this aspect include corresponding computer systems, apparatus, and computer programs recorded on one or more computer storage devices, each configured to perform the actions of the methods.

This specification uses the term “configured” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

The foregoing and other embodiments can each optionally include one or more of the following features, alone or in combination. In particular, one embodiment includes all the following features in combination. The system further includes one or more wireless enabled devices communicatively coupled to the first mobile device using a secure wireless network. The system further includes a bridge device communicatively coupled to the first mobile device, wherein the bridge device includes one or more transceivers configured to relay communications between one or more wireless devices and the first mobile device. The bridge device includes one or more of 433, Zwave, Zigbee, or Bluetooth transceivers. The first mobile device includes a camera configured to capture video data in response to a triggered alert or in response to a live video view request. The first mobile device includes a camera configured to capture video data and an accelerometer configured to detect movement of the first mobile device, wherein the security system management provided by the one or more installed applications uses the accelerometer to trigger an alert. The camera is configured to capture video data in response to a triggered alert or in response to a live video view request.

In general, one innovative aspect of the subject matter described in this specification can be embodied in methods that that include the actions of executing an installed security system management application on a mobile device; activating the mobile device to be used as a security system device through communication with a service provider server; periodically report mobile device location to service provider server; in response to a triggering event, transmitting an alert to the service provider server; capturing video data in response to the alert or in response to a live video view request; and transmitting event information to one or more authorized users through the service provider server. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. The method further includes receiving instructions from the service provider server in response to the transmitted event information. In response to the triggering event, the first mobile device emits a warning notice. The method includes determining whether the alarm is deactivated within a specified time; and in response to determining that the alarm is not deactivated, transmitting the alert to the service provider server. The triggering event includes displacement of an accelerometer of the mobile device. The triggering event includes receiving an alert from one or more wireless security devices communicatively coupled to the mobile device. Activating the mobile device includes: passing an first identifier of the mobile device to the service provider server; receiving a second identifier from the service provider server; presenting a representation of the second identifier on a display of the mobile device for capture by a distinct user device associated with a user account of the service provider server; and receiving activation confirmation from the service provider server. The representation of the second identifier is a QR code generated using the second identifier and readable by a QR reader of the user device.

Particular embodiments of the subject matter described in this specification can be implemented so as to realize one or more of the following advantages. A mobile phone can be used to provide a security system for a particular location. The use of a mobile phone with cellular data connectivity can allow placement of the security system in locations that were previously difficult to set up or cost prohibitive. For example, a mobile device can be used to establish a security system on a boat or other mobile location. Additionally, the mobile phone can use older generation wireless technology for data transmission, e.g., 3G vs. 4G, which can allow for significant cost savings in mobile device hardware and data rates.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system using a mobile device as a local security system.

FIG. 2 is a block diagram of an example system using a mobile device to manage a local security system.

FIG. 3 is a block diagram of an example system using a mobile device and a bridge device to manage a local security system.

FIG. 4 is a flow diagram of an example method for using a mobile device as a local security system.

FIG. 5 is a flow diagram of an example method for setting up a mobile device for use as a security system.

FIG. 6 is a flow diagram of an example method for triggering security system alerts.

FIG. 7 is a flow diagram of an example method of adding one or more wireless devices to the security system.

Like reference numbers and designations in the various drawings indicate like elements.

### DETAILED DESCRIPTION

Initial set up of a secure wireless network can be cumbersome when many of the wireless enabled devices to be included in the network lack user interfaces for working through a device installation process. As an example, a home surveillance system may include many wireless enabled cameras and numerous wireless enabled sensors that lack user interfaces to facilitate their addition to the home network.

Additionally, a local security system requires a security system management device that communicates with the wireless enable devices and a remote service provider system. The remote service provider system can be provided by one or more remote servers or a distributed cloud system distinct from the local security system and the user devices that interact with the security system. This specification describes a local security system that uses a mobile device such as a mobile phone as the security system management device and communication gateway for communicating with the devices of the secure wireless network and the service provider system.

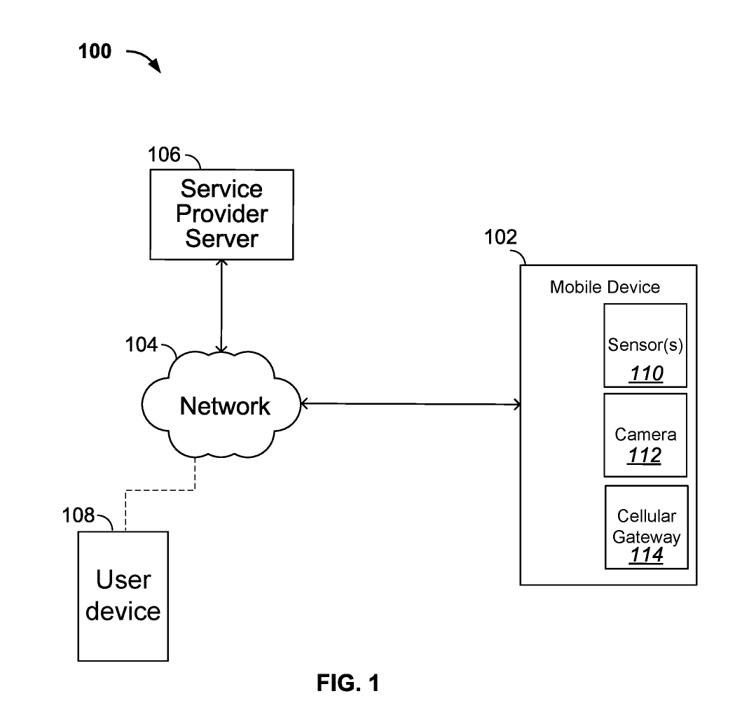

FIG. 1 is a block diagram of an example system 100 using a mobile device 102 as a local security system. The system 100 includes a mobile device 102, a network 104, a service provider server 106, and a user device 108.

The mobile device 102 includes one or more sensors 110, one or more cameras 112, and a cellular gateway 114. The mobile device 102 can be, for example, a mobile phone that includes a sim card to provide cellular data connectivity to network 104 using the cellular gateway 114. The mobile device 102 uses a wireless technology that provides suitable data bandwidth, which in some cases may use lower generation technology provided with lower data costs. The cellular data connectivity is sufficient to provide transmission of video data from the camera 112 and sensor data from the sensors 110 of the mobile device 102.

The mobile device 102 can also include one or more applications configured to provide security system functionality. For example, an application can be installed on the mobile device 102 that allows for the configuration and use of the one or more cameras 112 and one or more sensors 110 to provide security monitoring functions. For example, the application can use suitable APIs to access the camera and sensor hardware on the mobile device 102. Similarly, the operating system of the mobile device can provide the necessary software functionality to allow the application to access the one or more cameras 112 and one or more sensors 110. Similarly, the application can have access to transmit and receive data using the cellular gateway 114.

Additionally, the application can include security system rules, which may be user configurable, for setting security parameters and triggers. The application can provide one or more user interfaces for receiving user input, e.g., through a touchscreen interface.

The software application can automatically establish a connection with the remote service provider server 106, for example, upon execution of the application. The service provider server 110 interacts with the mobile device 102 and authorized devices, such as user device 108.

The service provider server 106 provides management and communication functions for the system 100. In particular, while only one mobile device 102 is shown, the service provider server 106 can be used to manage multiple different local security systems associated with corresponding user devices and mobile devices providing local security system management. The service provider server 106 can be one or more servers or a cloud based management system. The service provider server 106 can provide authentication and registration functions for establishing a secure wireless network using the mobile device 102 as well as for authenticating user control commands and requests. Furthermore the service provider server 106 can manage communication between the mobile device 102 and one or more user devices 108 associated with the mobile device 102.

The user device 108 represents various device types that can be used by one or more users to receive security data, e.g., alerts or video streams, and provide control instructions for the mobile device 102. For example, the user device 108 can be one of various types of smartphones that includes a security management application or a web browser for accessing a security management website.

When the user device 108 attempts to interact with the service provider server 106, its authority may be confirmed by the service provider server 106. For example, the user device 108 can provide information that uniquely identifies the requesting device, e.g., an Internet Protocol (IP) address, a product serial number, or a cell phone number. Alternatively, the user may provide a user name and password which are validated to determine authority to interact with the service provider server 106 and to access data associated with the local security system provided by mobile device 102. To facilitate such authorization procedures, the service provider server 106 can store, or have ready access to, authorization information for each secure wireless network of users who subscribe to the service. The user device 108 can be used to receive information from the local security server 106, e.g., alarm information, as well as used to control functions of the security system, e.g., to request video data from the mobile device 102.

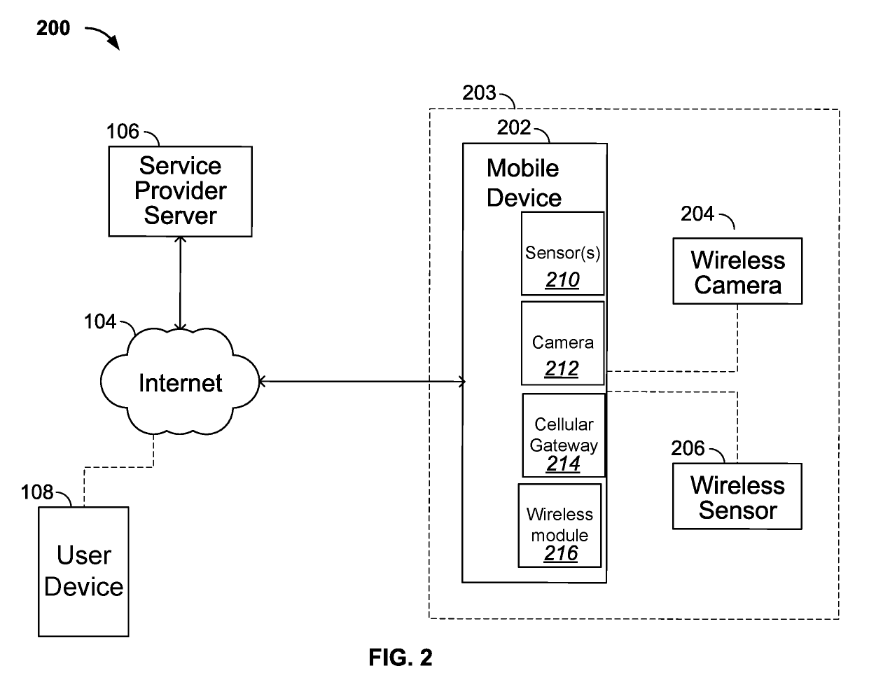

FIG. 2 is a block diagram of an example system 200 using a mobile device 202 to manage a local security system. The system 100 includes the mobile device 202, a network 104, a service provider server 106, and a user device 108. The service provider server 106, network 104, and user device 108 can be the same as described above with respect to FIG. 1. The mobile device 202 includes sensors 210, camera 212, cellular gateway 214 and wireless module 216.

The mobile device 202 can be, for example, a mobile phone that includes a sim card to provide cellular data connectivity to network 104 using the cellular gateway 214. The mobile device 202 uses a wireless technology that provides suitable data bandwidth, which in some cases may use lower generation technology provided with lower data costs. The cellular data connectivity is sufficient to provide transmission of video data from the camera 212 and sensor data from the sensors 210 of the mobile device 202. Additionally, the cellular gateway 214 can be used by the mobile device 202 to communicate data from the wireless camera 204 and wireless sensor 206.

The mobile device 202 can be used to form a local security system network 203 including wireless camera 204 and wireless sensor 206. The local security system network 203 can be a secure wireless network that uses a particular key to secure communications between devices. For example, using keys to establish a local security system network is described for example in U.S. Pat. No. 9,401,901 and U.S. Pat. No. 9,125,049, the contents of which are incorporated here by reference in their entirety. For example, in some implementations a generic or common key can be used to establish and initial connection with one or more wireless devices. This key can then be updated with a unique private key to establish a secure wireless network.

The wireless camera 204 can be an IP camera that connects to the mobile device using wireless communication. The wireless sensor 206 can be a motion sensor, a temperature sensor, a heat sensor, a flooding sensor, or other suitable security sensor. In some implementations, the wireless sensor 206 is a glass break sensor or opening sensor that detects opening or closing of doors or windows.

The wireless module 216 allows the mobile device 202 to operate as a WiFi hotspot. In WiFi hotspot mode, wireless devices to be joined to the secure wireless network 203 can join through the WiFi hotspot. For example, the wireless camera 204 can be WiFi enabled such that they can communicated with the mobile device 202 in WiFi hotspot mode. In some implementations, other sensors can include WiFi capability.

In some other implementations, the wireless module 216 of the mobile device 202 includes other communication functionality for connecting with non-WiFi sensors. For example, the wireless sensor 206 can use other communication protocols including Zigbee, Z-wave, or 433. The mobile device 202 can be configured with hardware for receiving and transmitting signals using those protocols. In some implementations, one or more wireless sensors can use Bluetooth communication. The mobile device 202 can pair with particular wireless sensors to join the wireless sensor to the network.

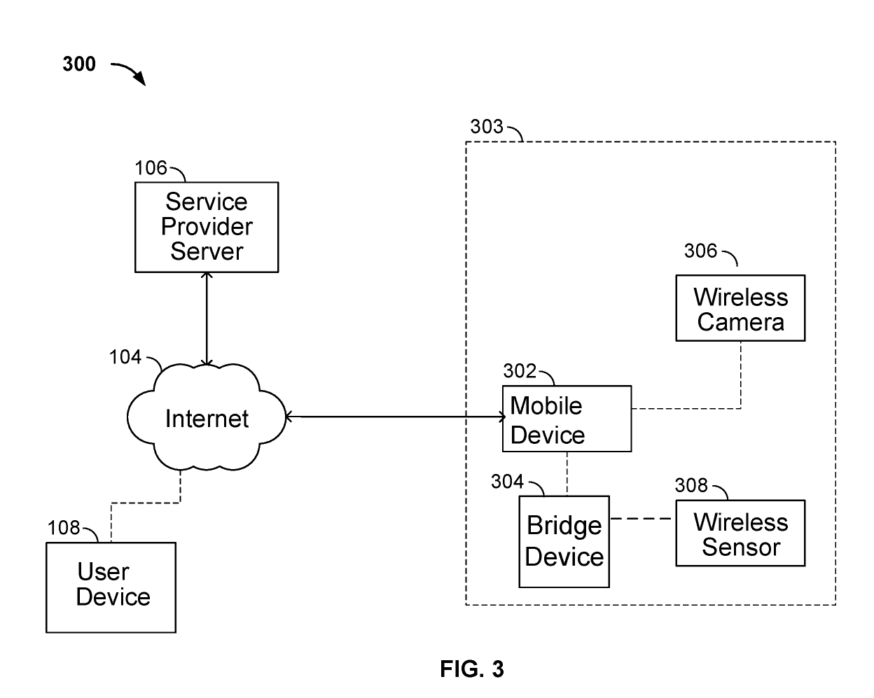

In some other implementations, a bridge device is used to joint non-WiFi devices to the network, as described below with respect to FIG. 3. Although only a single wireless camera and wireless sensor are shown in FIGS. 2-3, any suitable number and kind of cameras and sensors can be added to the secure wireless network using the technology described in this specification.

FIG. 3 is a block diagram of an example system 300 using a mobile device 302 and a bridge device 304 to manage a local security system. The system 300 includes the mobile device 302, a network 104, a service provider server 106, and a user device 108. The service provider server 106, network 104, and user device 108 can be the same as described above with respect to FIG. 1. The system further includes bridge device 304, wireless camera 306, and wireless sensor 308. The wireless camera 306 can be coupled with the mobile device 302 as part of a secure wireless network 303. In particular, the mobile device 302 can operate as a WiFi hotspot as described above with respect to FIG. 2.

In the example shown in FIG. 3, the wireless sensor 308 is not capable of coupling with the mobile device 302 directly. Instead, the wireless device 308 can communicatively couple with the bridge device 304. The bridge device 304 is a device having a one or more transceivers used to communicate with different types of devices, for example, 433, Zwave, Zibee, Bluetooth, and WiFi transceivers. The bridge device 304 operates as a relay that provides communication between these wireless devices and the mobile device 302.

The bridge device 304 is communicatively coupled to the mobile device 302. The bridge device 304 can communicate with wireless devices that use other communication protocols than are supported by the mobile device 302. For example, the wireless sensors 308 can use other communication protocols including Zigbee, Z-wave, or 433. The bridge device 304 is configured to send and receive communications with the wireless sensors 308 and relay communications to and from the mobile device 302. In some implementations, the bridge device 304 communicates with the mobile device 302 using WiFi communication, e.g., where the mobile device 302 is acting as a WiFi hotspot. In some other implementations, the bridge device 304 communicates with the mobile device 302 using a wired connection, for example, a USB on-the-go (“OTG” connection).

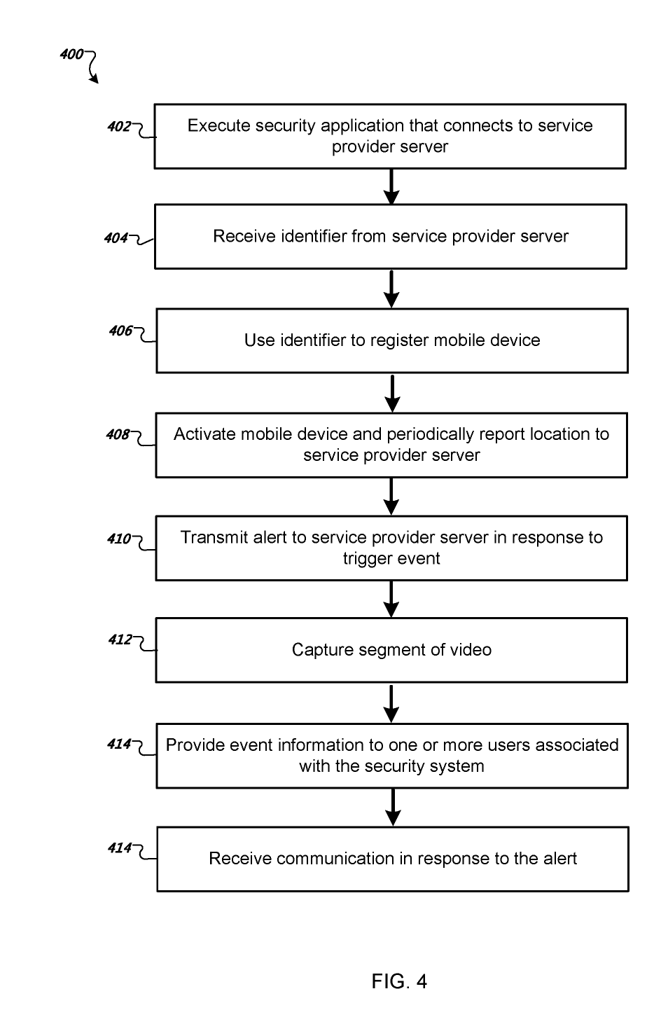

FIG. 4 is a flow diagram of an example method 400 for using a mobile device as a local security system. For convenience, the method 400 will be described with respect to a system that performs the method. In particular, the method 400 will be described with respect to a mobile device providing security system functions at a location, e.g., mobile device 102.

The mobile device executes a security system application that connects to a service provider server (402). The application can be installed by a user or preinstalled on the mobile device at purchase. Upon execution of the application, the application can interact with the operating system of the mobile deice to communicate with the service provider server using cellular data communication. Connecting to the service provider server includes providing a unique identifier to the service provider server as part of an activation request. This allows the service provider server to uniquely identify the particular mobile device. For example, the unique identifier can be a device ID of the mobile device or a phone number associated with the user device as the identifier.

Activation of the mobile device for uses as a security system device can include interaction between the mobile device, the service provider server, and a user device, e.g., the user's mobile phone distinct from the mobile device.

When the mobile device provides the service provider server with the device ID, the service provider server generates an identifier for use in activation and registers the mobile device.

The mobile device receives the identifier from the service provider server corresponding to a registration of the mobile device (404).

The mobile device uses the received number to register itself as a security system device to the service provider server (406). In some implementations, the received identifier is used to generate a representation of the identifier that can be displayed on a display of the mobile device. For example, the identifier can be used to generate a QR code that is read by the user device to link the mobile device to a particular user account. In particular, the user device can use the security system management application to scan the QR code on the mobile device. The user device can then transmit the identifier from the QR code to the service provider server along with an activation request. This allows the server to link a particular user account to the particular mobile device being activated.

The mobile device is activated as a security system device and periodically reports the current location to the service provider system (408). The service provider server links the mobile device with an account of the user device. As a security system device, a user can configure one or more security settings and position the mobile device in a location for providing security monitoring. For example, the mobile device can be positioned so that a camera of the mobile device can capture a particular field of view. The application can use a global positioning system (GPS) module of the mobile device to provide the periodic location reports to the service provider server using cellular communications.

In some implementations, after the mobile device is activated as a security system device, the mobile device can add one or more wireless enabled devices to form a local security system joined using a secure wireless network.

In response to a trigger event, the mobile device transmits an alert to the service provider server (410). Trigger events can include predefined triggers as well as user specified triggers, for example, input to a user interface of the application on the mobile device. In some implementations, a trigger alert can based on motion of the mobile device. Motion of the mobile device can be detected, for example, using the accelerometer of the mobile device as a motion sensor. This can detect vibration or other movement of the mobile device. Another trigger can be a signal from one or more external sensor devices in communication with the mobile device, for example as described above with respect to FIG. 2. For example, a break sensor can be triggered and transmit a signal to the mobile device.

In some implementations, the trigger can be based on a panic button being triggered, for example, by a person near the mobile device.

The mobile device captures a segment of video contemporaneously with the trigger event and transmits the video to the service provider server (412). For example, the camera can be automatically activated by the application when a trigger event is detected. The length of recording can be specified, e.g., 30 seconds or 1 minute. In some implementations where there are additional cameras, e.g., wireless cameras coupled to the mobile device as part of a secure wireless network, video can be selectively captured from one or more of these additional cameras.

The service provider server can provide event information to one or more users associated with the security system provided by the mobile device (414). For example, a notification can be sent to a user device associated with an authorized user, e.g., user device 106. The notification can include information about the type of trigger event, the location of the mobile device, the time of the event, and the captured video segment.

The user can request additional information or provide instructions. In some implementations, a trigger event corresponds to a false alarm, for example verified by the authorized user using the video. In some implementations, where a response is warranted, the user can instruct the service provider server to notify appropriate authorities, e.g., police, fire, or medical assistance. In some implementations, the user can provide additional requests to be provided to the mobile device, e.g., through the service provider server. For example, the user can request to view live video to see the current situation in the field of view.

The mobile device can receive a communication in response to the alert (416). The communication can be from the service provider server or as relayed from the user device of the authorized user. For example, the communication can be a request for further information such as additional captured video content. The communication can be an instruction to treat the trigger alert as a false alarm. The communication can be a request to activate an alarm at the location.

The interaction between the user device and the service provider server is described in further detail in U.S. Pat. No. 9,401,901 and U.S. Pat. No. 9,125,049, incorporated by reference above.

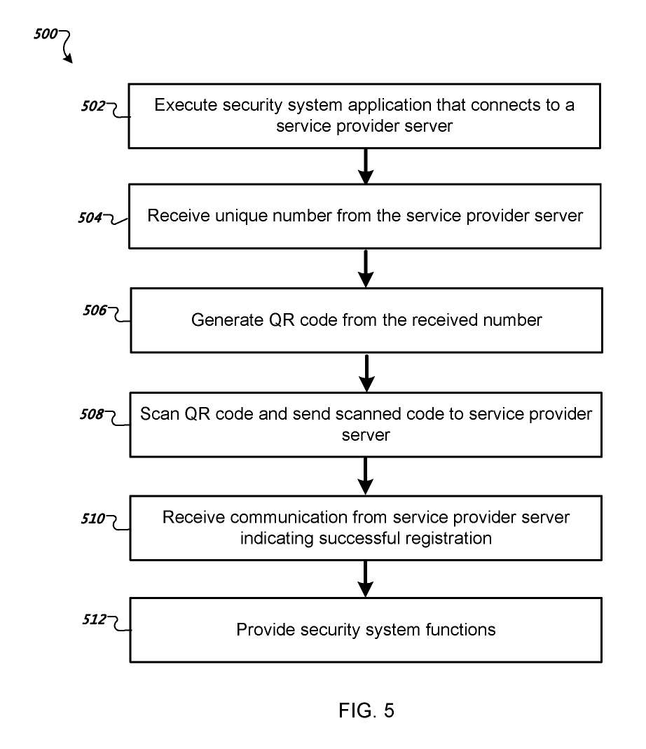

FIG. 5 is a flow diagram of an example method 500 for setting up a mobile device for use as a security system. For convenience, the method 500 will be described with respect to a mobile device, e.g., mobile device 102, that carries out the method.

The mobile device executes a security system application which connects to a service provider server (502). The application can be installed by a user or preinstalled on the mobile device at purchase. Upon execution of the application, the application can interact with the operating system of the mobile deice to communicate with the service provider server using cellular data communication. Connecting to the service provider server includes providing a unique identifier to the service provider server as part of an activation request. This allows the service provider server to uniquely identify the particular mobile device.

The service provider server generate a unique identifier, registers it as a security system device, and returns the unique identifier to the mobile device.

The mobile device receives the unique identifier from the service provider server corresponding to a registration of the mobile device (504). For example, the service provider server can assign the identifier in response to receiving the activation request.

The mobile device generates a QR code based from the received number (506). The user uses an application on their user device, e.g., a security management application, to scan the QR code and send the scanned code to the service provider server to activate the mobile device (508). In particular, the combination of the identifier extracted from the QR code and the account identifier of the user (e.g., through a login using the security management application) allows the service provider server to link the mobile device and the user account.

The mobile device receives a communication from the server provider server indicating that the mobile device has been successfully registered to an account of a particular user (510).

The mobile device begins to provide security system functions including sensing using one or more sensors of the mobile device and gateway communications from the application of the mobile device to the service provider server (512).

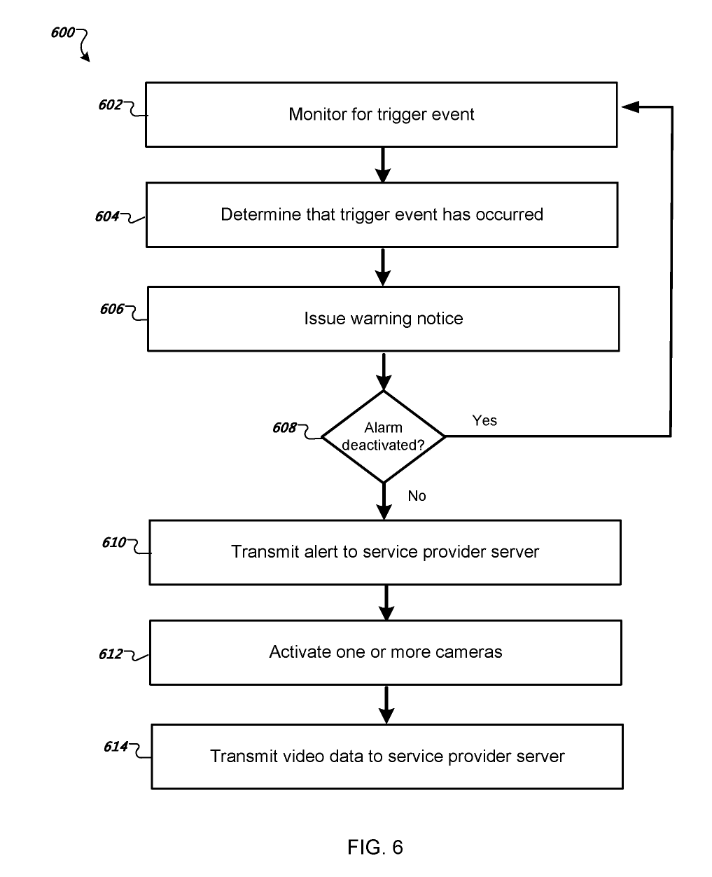

FIG. 6 is a flow diagram of an example method 600 for triggering security system alerts. For convenience, the method 500 will be described with respect to a mobile device, e.g., mobile device 102, that carries out the method.

The mobile device monitors for a trigger event to occur (602). The monitoring can be passive, for example, waiting for a signal from a sensor. In some implementations, the monitoring is active and the mobile device application receives data from the sensors and/or cameras and analyzes the data to determine whether or not a trigger event has occurred.

The mobile device determines that a trigger event has occurred (604). Trigger events can include predefined triggers as well as user specified triggers. For example, a trigger alert can based on motion of the mobile device. Motion of the mobile device can be detected, for example, using the accelerometer of the mobile device as a motion sensor. This can detect vibration or other movement of the mobile device. Another trigger can be a signal from one or more external sensor devices in communication with the mobile device, for example as described above with respect to FIG. 2. For example, a break sensor can be triggered and transmit a signal to the mobile device.

In some implementations, the trigger can be based on a panic button being triggered, for example, by a person near the mobile device.

The mobile device issues a warning notice (606). The warning notice can be a chime or verbal warning indicating that the security system has been triggered.

The mobile device determines whether the triggered alert has been deactivated by an authorized user prior to a timer elapsing (608). For example, a timer can begin counting down upon issuing the warning notice. The length of the timer can be predefined or user specified, for example, 10 seconds. An authorized user can deactivate the security system for example, by providing a particular input to an application user interface of the mobile device or an application user interface of a user device. The input can include a passcode or biometric information.

In response to determining that the alert has been deactivated, the mobile device can return to monitoring activity data (608 “yes” branch). In some implementations, the monitoring stops until the mobile device is reactivated by an authorized user.

In response to determining that the alert has not been deactivated (608 “no” branch), the mobile device transmits an alert to the service provider server (610). The alert information can include an identifier of the alert and an identifier for the security system device or account.

The mobile device activates one or more cameras in response to the alert (612). In a security system that uses the mobile device as the sole device of the system, the integrated camera of the mobile device is activated. In some other implementations, one or more other cameras, e.g., IP cameras, can be added to the security system as described above. One or more of these other cameras can be activated in addition to or in place of the integrated camera of the mobile device. Each camera captures video content for a specified period of time, e.g., 10 seconds. When capturing video from multiple cameras the capture can be done in parallel or sequentially.

The mobile device transmits video data to service provider server (614). In some implementations, the video data is compressed using a suitable compression technique prior to transmission. In some other implementations, the video data is encrypted prior to transmission.

In some implementations, the user of a user device can use a security system management application on the user device to view or capture video content from the mobile device. For example, the user can request a live view or specified video capture using the management application. The management application can then provide the request to the service provider server, which then passes the request along to the associated mobile device. The mobile device, upon receipt, can activate the camera of the mobile device and/or one or more connected wireless enabled camera devices to capture information. After video capture, the mobile device can transmit the video data to the service provider server, which then provides the video data to the user device.

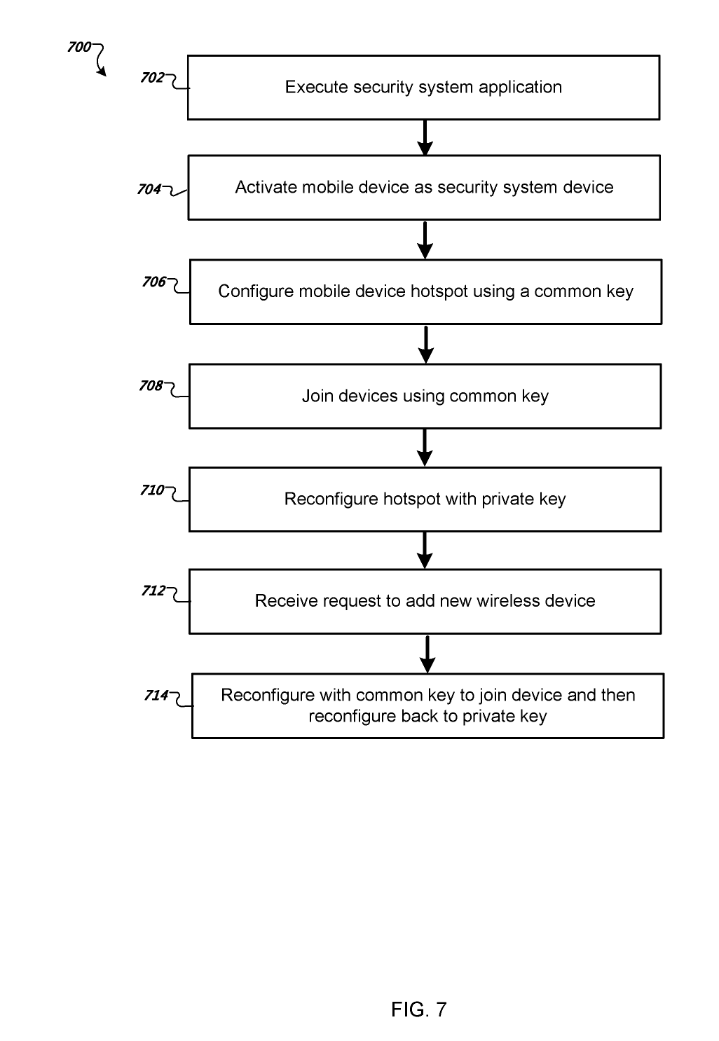

FIG. 7 is a flow diagram of an example method of adding one or more wireless devices to the security system. For convenience, the method 700 will be described with respect to a mobile device, e.g., mobile device 102, that carries out the method.

The mobile device executes a security system application which connects to a service provider server (702). The application can be installed by a user or preinstalled on the mobile device at purchase. Upon execution of the application, the application can interact with the operating system of the mobile deice to communicate with the service provider server using cellular data communication.

The application communicates with the service provider system to activate the mobile device as a security system device (704). The activation can be performed as described above with respect to FIG. 5.

The application configures the mobile device hotspot using a common key (706). Using a common key allows other devices having the same default key to communicate with the mobile device. In some implementations, different wireless enabled devices can be preinstalled with a common key to facilitate use in the security system. Using the common key, the application can join any wireless enabled devices to be added to the security system (708).

The application reconfigures the hotspot with a private key (710). The application can use the mobile device to communicate the private key to any joined wireless enabled devices. Therefore, after switching to the private key, the mobile device can securely communicate with the wireless enabled devices.

The mobile device receives a request from the service provider server to add a new wireless enabled device to the network of the security system (712). In response to the request, the mobile device configures the hotspot to the common key and establishes communication with the new wireless enabled device (714). The mobile device then promulgates the private key to the new wireless enabled device and reconfigures the mobile device hotspot to the private key. This process can repeat for subsequent requests to add new wireless enabled devices. In addition, the application can periodically pass a new private key to the wireless enabled devices and reconfigure the hotspot to the new private key.

### Example Security System Scenarios

In some implementations, a user can establish a security system as described above for use in a location other than a primary residence. For example, the user can use a mobile device to establish a security system on a boat, RV, or car. In particular, this provides for security coverage at a location that can change using cellular technology. Additionally, it provides a solution for monitoring a location that is unattended using economical devices.

In some other implementations, fleet operators can use the mobile device security systems to monitory fleet operations. For example, a delivery or trucking company can incorporate the mobile devices to provide monitoring not only of the integrity of the vehicles but also to track locations and deliveries. For example, the GPS functions of the mobile device track locations and one or more cameras can be positioned to capture delivery activity.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A security system comprising:
a first mobile device, the first mobile device including one or more installed applications for providing security system management;
a service provider system communicatively coupled to the first mobile device; and
a user mobile device configured to provide user access to security system information from the first mobile device through the service provider system.

2. The security system of claim 1, further comprising:
one or more wireless enabled devices communicatively coupled to the first mobile device using a secure wireless network.

3. The security system of claim 1, further comprising:
a bridge device communicatively coupled to the first mobile device, wherein the bridge device includes one or more transceivers configured to relay communications between one or more wireless devices and the first mobile device.

4. The security system of claim 3, wherein the bridge device includes one or more of 433, Zwave, Zigbee, or Bluetooth transceivers.

5. The security system of claim 1, wherein the first mobile device includes a camera configured to capture video data in response to a triggered alert or in response to a live video view request.

6. The security system of claim 1, wherein the first mobile device includes a camera configured to capture video data and an accelerometer configured to detect movement of the first mobile device, wherein the security system management provided by the one or more installed applications uses the accelerometer to trigger an alert.

7. The security system of claim 6, wherein the camera is configured to capture video data in response to a triggered alert or in response to a live video view request.

8. A method comprising:
executing an installed security system management application on a mobile device;
activating the mobile device to be used as a security system device through communication with a service provider server;
periodically report mobile device location to service provider server;
in response to a triggering event, transmitting an alert to the service provider server;
capturing video data in response to the alert or in response to a live video view request; and
transmitting event information to one or more authorized users through the service provider server.

9. The method of claim 8, further comprising:
receiving instructions from the service provider server in response to the transmitted event information.

10. The method of claim 8, wherein in response to the triggering event, the first mobile device emits a warning notice.

11. The method of claim 10, comprising:
determining whether the alarm is deactivated within a specified time; and
in response to determining that the alarm is not deactivated, transmitting the alert to the service provider server.

12. The method of claim 8, wherein the triggering event comprises displacement of an accelerometer of the mobile device.

13. The method of claim 8, wherein the triggering event comprises receiving an alert from one or more wireless security devices communicatively coupled to the mobile device.

14. The method of claim 8, wherein activating the mobile device comprises:
passing an first identifier of the mobile device to the service provider server;
receiving a second identifier from the service provider server;
presenting a representation of the second identifier on a display of the mobile device for capture by a distinct user device associated with a user account of the service provider server; and
receiving activation confirmation from the service provider server.

15. The method of claim 14, wherein the representation of the second identifier is a QR code generated using the second identifier and readable by a QR reader of the user device.
